(19) United States
(12) Patent Application Publication
(10) Pub. No.: US 2006/0048645 A1
(43) Pub. Date: Mar. 9, 2006

(54) Process for the removal of arsine from a hydrocarbon stream with an adsorbent

(76) Inventors: Leonardus Hubertus Postma, Kerkrade (NL); Antonius Corvers, Geleen (NL)

Correspondence Address: MAYER, BROWN, ROWE & MAW LLP, 1909 K STREET, N.W., WASHINGTON, DC, 20006, US

(21) Appl. No.: 10/509,081

(22) PCT Filed: Mar. 28, 2003
(86) PCT No.: PCT/NL03/00241

§ 371 Date: Jun. 21, 2005

(30) Foreign Application Priority Data
Apr. 3, 2002 (NL) 1020296

(51) Int. Cl. B01D 53/02

(52) U.S. Cl. 95/134

(57) ABSTRACT

A process for the removal of arsine (AsH₃) from a hydrocarbon stream, having an atmospheric boiling point lower than about 0° C., by contacting the hydrocarbon stream with an adsorbent that contains elemental sulphur deposited on a support material. The amount of sulfur is in the range between 5 and 25 wt. % relative to the total amount of sulfur and support material. In addition, to arsine, mercury may also be removed from the hydrocarbon stream.

The invention relates to a process for the removal of arsine (AsH₃) from a hydrocarbon stream with an adsorbent.

Arsine removal methods are summarised by J. A. Reid in “Introduction to arsine and arsenic compounds removal methods” presented at the AlChE EPC Seminar on Arsine, Houston, Mar. 7, 1997.

The presence of arsine in a hydrocarbon stream is a problem because it may act as a poison for a catalyst to be used for the further processing of such a hydrocarbon stream, such as for example a hydrogenation catalyst. The presence of arsine is a specific problem for a feed comprising mainly, for example more than 70 vol. %, of hydrocarbons containing 1-3 carbon atoms. These hydrocarbon streams have an atmospheric boiling point lower than about 0° C. These streams may contain arsine however these streams will not contain alkyl arsines, such as mono-, di- and trialkyl arsines.

It is the object of the present invention to provide a process for the removal of arsine from the hydrocarbon streams with an atmospheric boiling point less than 0° C.

The process according to the present invention is characterized in that the hydrocarbon stream is contacted with an adsorbent comprising elemental sulphur deposited on a support material.

Under normal conditions (atmospheric pressure, room temperature) the hydrocarbon stream with an atmospheric boiling point lower than 0° C is gaseous. Depending on the temperature and pressure applied, however, such a hydrocarbon stream may be liquid.

The hydrocarbon stream may contain compounds such as, for instance, propane, propylene, ethane, ethylene, methane and/or acetylene. The stream may contain for example at least 70 vol. % propylene and/or ethylene.

The adsorption column contains elemental sulphur deposited on a support material such as for example silica, alumina, silica/alumina, titania, zeolites, activated carbon and/or magnesia.

According to a preferred embodiment of the invention the support material is activated carbon because it is an advantage of activated carbon that it has a relatively large surface area per unit volume compared with other support materials and furthermore activated carbon does not contain any acid or basic sites which may initiate an undesired polymerisation of compounds being present in the hydrocarbon stream.

The elemental sulphur may be applied to the support material for instance by impregnating or spraying the support material with a solution of the sulphur, or by impregnating the support material with molten sulphur, or by subliming sulphur on the support material.

Generally, the amount of sulphur is less than 35 wt % of the total amount of sulfur and support material.

According to a preferred embodiment of the invention the amount of sulfur is in the range between 2 and 25 wt %.

The hydrocarbon stream is passed over the adsorption column that contains the elemental sulphur deposited on the support material. The process according to the invention may be carried out in any suitable manner and the adsorption column may have any desirable shape and any desirable volume. Preferably the adsorption column is a fixed bed. The stream may pass in either upward and downward flow.

Generally, the pressure ranges between atmospheric pressure and 2.5 MPa. The selection depends on the temperature during the passing over of the hydrocarbon stream and the pressure is preferably chosen so that the hydrocarbon stream remains gaseous.

Generally, the temperature ranges between 15° C. and 100° C. At a temperature higher than 100° C., sublimation of sulphur from the adsorption column may become significant. This is undesirable, since sulphur may act as a poison for catalysts that are used to a process the hydrocarbon stream.

The process according to the invention is generally carried out with a gas hourly space velocity (GHSV) in the range between 1000 and 50000 h⁻¹ wherein GHSV is defined as [number of Nm³ gas per hour]/[m³ adsorbent]

Besides arsine, the hydrocarbon stream may also contain other impurities such as for example heavy metals, in particular mercury. The process according to the invention also removes mercury from the hydrocarbon stream.

In contrast to the present invention which is directed to the removal of arsine EP-A-488235 discloses a process to remove trialkyl arsines. These trialkyl arsines are removed from a fluid with a solid adsorbent that contains an inorganic support and elemental sulphur. In the process according to EP-A-488235 the removal of arsine (AsH₃) and/or H₂S from the feed takes place with a guard bed of a supported CuO—ZnO material or PbO/Al₂O₃. The removal of trialkyl arsines from the fluid is carried out in a second step by contacting the fluid with said solid adsorbent. Consequently EP-A-488235 does not teach and does not give any indication for the use of an adsorbent that contains elemental sulphur deposited on a support material to remove arsine.

The invention will be elucidated by means of the following examples without being restricted thereto.

### EXAMPLES I-III

The Examples I-III were carried out in a fixed-bed set-up with the following adsorbents A, B and C:
A: Calgon HGR, sulphur on activated carbon; sulphur content 10-18 wt. %.,
B: Sud Chemie MIS-2, sulphur on activated carbon; sulphur content 15 wt. %. and
C: Norit RBHG-3, sulphur on activated carbon; sulphur content approximately 10 wt. %,
   were tested for 7 days at a temperature of 30° C., atmospheric pressure and at a gas hourly space velocity (GHSV) of 1700 h⁻¹.

The feed consisted of a hydrocarbon stream comprising 93 vol. % propylene, 3.5 vol. % propane and 3.5 vol. % residuals such as for example methyl acetylene and propadiene. The feed contained 250 mg/kg AsH₃ and 2000 mg/kg Hg.

During the experiment samples were taken of the feed and of the treated gas. The gas samples were analysed by means of Inductive Coupled Plasma-Mass Spectrometry (ICP-MS).

TABLE I

| | | | Mercury removal |
|---|---|---|---|
| Adsorbent | Time (hours) | Arsine removal | (%) |
| A | 33 | 100 | 100 |
| | 49 | 100 | 99 |
| | 98 | 100 | 96 |
| | 121 | 100 | 89 |
| | 143 | 100 | 92 |

TABLE II

| | | Arsine removal | Mercury removal |
|---|---|---|---|
| Adsorbent | Time (hours) | (%) | (%) |
| B | 1 | 100 | 98 |
| | 32 | 100 | 88 |
| | 72 | 100 | 79 |
| | 102 | 100 | 79 |
| | 125 | 100 | 80 |

TABLE III

| | | Arsine removal | Mercury removal |
|---|---|---|---|
| Adsorbent | Time (hours) | (%) | (%) |
| C | 3 | 100 | 100 |
| | 22 | 100 | 100 |
| | 46 | 100 | 99 |
| | 97 | 100 | 92 |
| | 148 | 100 | 86 |

1. A process for the removal of arsine (AsH₃) from a hydrocarbon stream having an atmospheric boiling point lower than about 0° C., by contacting the hydrocarbon stream with an adsorbent that contains elemental sulphur deposited on a support material.

2. A process according to claim 1, wherein the hydrocarbon stream contains propane, propylene, ethane, ethylene, methane and/or acetylene

3. A process according to claim 1, wherein the amount of sulfur is in the range between 2 and 25 wt. % relative to the total amount of sulfur and support material .

4. A process according to claim 1, wherein the support material is silica, alumina, silica/alumina, titania, zeolites, activated carbon and/or magnesia.

5. A process according to claim 4, wherein the support material is activated carbon.

6. A process according to claim 1, wherein besides arsine, mercury is also removed from the hydrocarbon stream.

7. A process according to claim 2, wherein the amount of sulfur is in the range between 2 and 25 wt. % relative to the total amount of sulfur and support material.
